(19) United States
(12) Patent Application Publication
(10) Pub. No.: US 2003/0036305 A1
(43) Pub. Date: Feb. 20, 2003

(54) Non-environmentally-hazardous wire harness

(76) Inventor: Yukio Noguchi, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/200,754

(22) Filed: Jul. 24, 2002

(30) Foreign Application Priority Data
Jul. 24, 2001 (JP) 2001-223337

(51) Int. Cl. H01R 11/00

(52) U.S. Cl. 439/502

(57) ABSTRACT

A wire harness including at least one cable including at least one conductive line for electrically connecting electric components, and a core insulating tube covering the at least one conductive line, wherein the core insulating tube comprises a non-hazardous material which does not produce at least one of a poisonous gas and material containing at least one of bromine, chlorine and dioxin.

### CROSS-REFERENCE TO RELATED APPLICATIONS

The present application claims priority to Japanese Patent Application No. 2001-223337, filed Jul. 24, 2001. The contents of that application are incorporated herein by reference in their entirety.

### BACKGROUND OF THE INVENTION

1. Field of the Invention

The present invention relates to a wire harness which is not hazardous to the environment.

2. Discussion of the Background

Wire harnesses are widely used in office equipment such as a copying machine, a facsimile machine, a printer, and a scanner as well as in home appliances and precision equipment such as audio equipment, to supply powers and to intercommunicate between electric components in these machines.

The wire harness generally includes conductive lines coated with an insulating material. The insulating material is usually made of polyvinyl chloride (PVC) because of its inexpensiveness.

However, when the polyvinyl chloride (PVC) is disposed into the earth or is incinerated, it causes environmental problems since the polyvinyl chloride (PVC) discharges a poisonous gas or material such as bromine, chlorine, and dioxin. Therefore, when the wire harness with the insulating material for coating the conductive lines is removed and disposed in the earth or incinerated during the recycling process, it have a hazardous effect on the environment.

### SUMMARY OF THE INVENTION

According to one aspect of the present invention, a wire harness includes at least one cable including at least one conductive line for electrically connecting electric components, and a core insulating tube covering the at least one conductive line, wherein the core insulating tube comprises a non-hazardous material which does not produce at least one of a poisonous gas and material containing at least one of bromine, chlorine and dioxin.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic illustration for explaining a structure of a wire harness according to one embodiment of the present invention;

FIG. 2 is a schematic illustration of a copying machine using the wire harness of FIG. 1;

FIG. 3 is an illustration of the wire harness connected to a printed circuit board;

FIG. 4 is an illustration showing when the printed circuit board is removed; and

FIG. 5 is an illustration showing a further detailed structure of the wire harness.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each element includes all technical equivalents that operate in a similar manner.

Referring now to the drawings, wherein like reference numerals designate identical or corresponding parts throughout the several views.

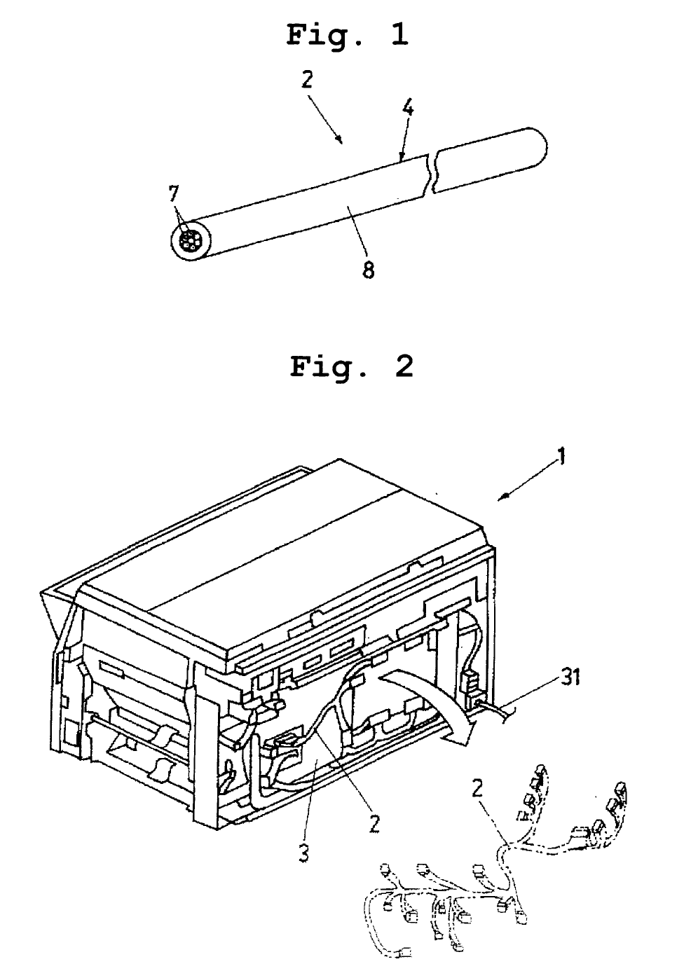

FIG. 1 illustrates an exemplary structure of a cable 4 included in a wire harness 2 according to the present invention. The cable 4 includes a plurality of conductive lines 7 and a core tube 8. As illustrated in FIG. 1, the conductive lines 7 are wrapped with the core member 8 which is an electrical insulation material. The wire harness 2 including this cable 4 is used to make electrical connections through the conductive lines 7 among electrical components in electrical equipment, e.g., a copying machine 1, as illustrated in FIG. 2.

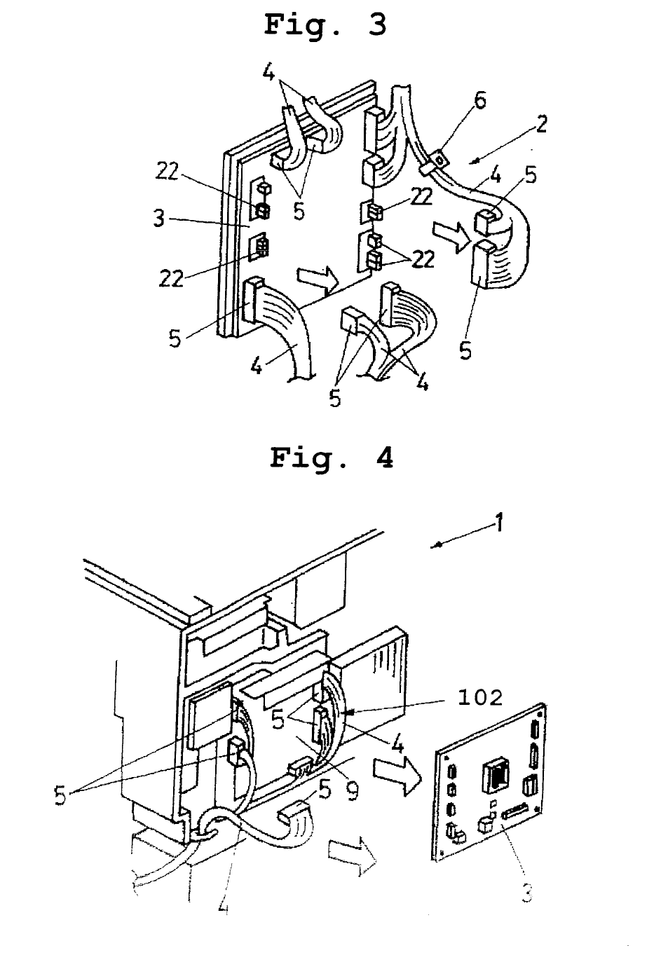

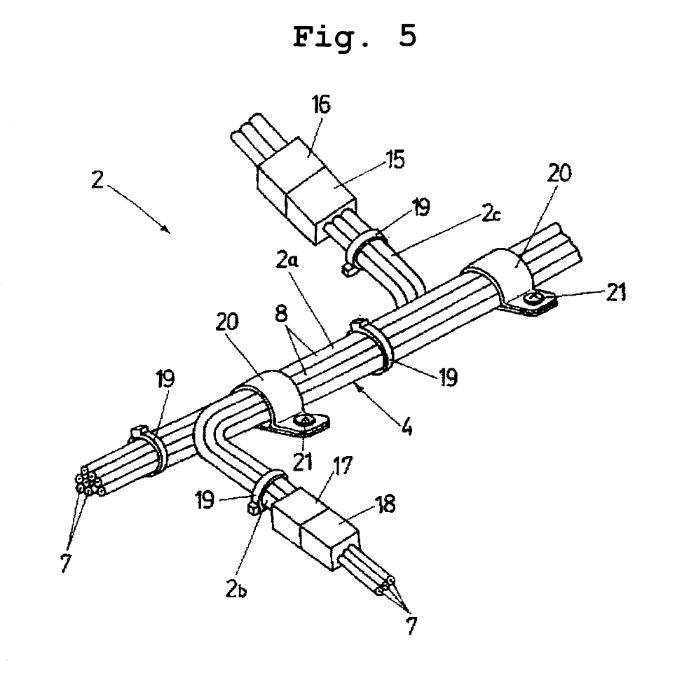

The wire harness 2 includes a plurality of the cables 4 provided with a plurality of electrical connectors 5 for an electrical connection, as illustrated in FIG. 3. Also, the cables 4 may be connected with electrical connectors 15-18, e.g., a crimp contact, at arbitrary portions of the cables 4 which require an electrical connection, as illustrated in FIG. 5.

The conductive lines 7 of the cable 4 may be a stranded wire made of a plurality of tinned and annealed copper wires. The surface of the tinned and annealed copper wires may be coated with tin.

The cables 4 are grouped into a plurality of cable bundles each of which is fixed with a plastic tie 6, if necessary, as illustrated in FIG. 3.

As illustrated in FIG. 2, the wire harness 2 is arranged at the rear side of a copying machine 1, for example, to make electrical connections among electrical components in the copying machine 1, including a printed circuit board 3, a power supply unit 9 (see FIG. 4), and other electrical components (not shown) including a main motor, a fan motor, photo sensors, actuators, and so on. These electrical components are respectively fixed with screws or the like to a frame member (not shown) of the copying machine 1.

In the copying machine 1, the wire harness 2 may be removed in a relatively simple manner. A rear cover (not shown) is removed from the copying machine 1. Then, the connectors 5 (see FIG. 3) are disconnected from connectors 22 which are fixed to the printed circuit board 3 or the cables 4 are cut at portions as closer to the ends as possible with a wire cutting tool, so that the wire harness 2 is removed in a way, as illustrated in ghost lines in FIG. 2.

Then, the printed circuit board 3 is removed from the copying machine 1, as illustrated in FIG. 4. After the removal of the printed circuit board 3, the power supply unit 9 provided with a wire harness 102 is exposed. The wire harness 102 makes electrical connections among internal electrical components, as illustrated in FIG. 4.

To remove the wire harness 102, either the connectors 5 are disconnected or the cables 4 are cut, as is the case with the removal of the wire harness 2.

Further details of the wire harness 2 is illustrated in FIG. 5. The wire harness 2 has a mother line (2a) which is divided into a plurality of branch wire harnesses including branch wire harnesses (2b, 2c). Each of the mother line (2a) and the branch wire harnesses (2b, 2c) is bundled with a plastic tie 19. The thus-structured wire harness 2 is fixed to mounting portions of the copying machine 1 with fixing members 20 and screws 21.

A core member of a wire harness made of polyvinyl chloride (PVC) causes environmental problems, e.g., the polyvinyl chloride (PVC) discharges a poisonous gas or material containing bromine, chlorine, or dioxin if the polyvinyl chloride (PVC) is disposed into the earth or incinerated.

Therefore, according to one embodiment of the present invention, the core members 8 of the wire harnesses 2, 102 are made of materials which do not discharge poisonous gas or materials. For example, preferred materials to be used for the core member 8 are TEFLON, i.e., polytetrafluoroetylene, resin, olefin resins, e.g., polyethylene and polyolefin resins, a polyester resin, and a rubber material, e.g., a natural rubber, ethylene, styrene, silicon, etc., or a mixture thereof. It is also preferable to use a hydroxide compound such as magnesium hydroxide, aluminum hydroxide, or the like which are a de-halogenate flame-retarding material rather than a flame-retarding material containing halogens such as chlorine and bromine or a halogen compound containing chlorine or bromine.

That is, the core member 8 is made of a material which does not contain a toxic heavy metal such as lead, hexavalent chromium, cadmium, and azoth, and a phosphatide or phosphoric compound.

Therefore, since the core member 8 of the wire harness 2, 102 is made of materials not hazardous to the environment, as described above, the above-described environmental problem related to polyvinyl chloride (PVC) can be avoided.

Furthermore, with the above-described core member 8 made of materials not hazardous to the environment, the wire harness 2, 102 may not necessarily be removed from the copying machine 1 when the copying machine 1 itself is disposed. Therefore, a time for disassembling the copying machine 1 may be reduced.

The wire harness 2 may also be used to a power cable 31 of the copying machine 1 shown in FIG. 2.

Furthermore, the wire harness 2 may be applied to wire harnesses used in any electrical office equipment such as a facsimile machine, a printer, a scanner, a multi-function machine, etc.

Moreover, the wire harness 2 can also be used in home appliances, audio equipment, electric components used in automobiles, computers, etc.

Numerous additional modifications and variations are possible in light of the above teachings. It is therefore to be understood that within the scope of the appended claims, the disclosure of this patent specification may be practiced otherwise than as specifically described herein.

What is claimed as new and desired to be secured by Letters Patent of the United States is:

1. A wire harness comprising at least one cable including at least one conductive line for electrically connecting electric components, and a core insulating tube covering the at least one conductive line, wherein the core insulating tube comprises a non-hazardous material which does not produce at least one of a poisonous gas and material containing at least one of bromine, chlorine and dioxin.

2. A wire harness as defined in claim 1, wherein the non-hazardous material comprises a polytetrafluoroetylene resin.

3. A wire harness as defined in claim 1, wherein the non-hazardous material comprises an olefin resin.

4. A wire harness as defined in claim 1, wherein the non-hazardous material comprises a polyester resin.

5. A wire harness as defined in claim 1, wherein the non-hazardous material comprises a rubber material.

6. A wire harness as defined in claim 1, wherein the non-hazardous material comprises a material selected from the group consisting of a polytetrafluoroetylene resin, an olefin resin, a polyester resin, a rubber material, and a mixture thereof.

7. A wire harness as defined in claim 1, wherein the non-hazardous material comprises a de-halogenate flame-retarding material which does not contain chlorine, bromine and a halogen compound of at least one of chlorine and bromine.

8. A wire harness comprising:
conductive means for electrically connecting a plurality of electric components; and
insulating means for insulating the conductive means,
wherein the insulating means comprises a non-hazardous material which does not produce at least one of a poisonous gas and material containing at least one of bromine, chlorine and dioxin.

9. A wire harness as defined in claim 8, wherein the non-hazardous material comprises a polytetrafluoroetylene resin.

10. A wire harness as defined in claim 8, wherein the non-hazardous material comprises an olefin resin.

11. A wire harness as defined in claim 8, wherein the non-hazardous material comprises a polyester resin.

12. A wire harness as defined in claim 8, wherein the non-hazardous material comprises a rubber material.

13. A wire harness as defined in claim 8, wherein the non-hazardous material comprises a material selected from the group consisting of a polytetrafluoroetylene resin, an olefin resin, a polyester resin, a rubber material, and a mixture thereof.

14. A wire harness as defined in claim 8, wherein the non-hazardous material comprises a de-halogenate flame-retarding material which does not contain chlorine, bromine and a halogen compound of at least one of chlorine and bromine.

15. An image forming apparatus comprising at least one wire harness including at least one cable having at least one conductive line for electrically connecting electric components, and a core insulating tube covering the at least one conductive line, wherein the core insulating tube comprises a non-hazardous material which does not produce at least one of a poisonous gas and material containing at least one of bromine, chlorine and dioxin.

16. An image forming apparatus as defined in claim 15, wherein the non-hazardous material comprises a material selected from the group consisting of a polytetrafluoroetylene resin, an olefin resin, a polyester resin, a rubber material, and a mixture thereof.

17. An image forming apparatus as defined in claim 15, wherein the non-hazardous material comprises a de-halogenate flame-retarding material which does not contain chlorine, bromine and a halogen compound of at least one of chlorine and bromine.
